(19) United States
(12) Patent Application Publication
(10) Pub. No.: US 2025/0097014 A1
(43) Pub. Date: Mar. 20, 2025

(54) SECURED DISTRIBUTION OF A DIGITAL CINEMA PACKAGE (DCP)

(71) Applicant: SR Labs, Inc., West Hollywood, CA (US)

(72) Inventors: Prem Akkaraju, Los Angeles, CA (US); Sean Holahan, Long Beach, CA (US)

(21) Appl. No.: 18/468,169

(22) Filed: Sep. 15, 2023

(51) Int. Cl. H04L 9/08; H04L 65/60; H04N 21/8358

(52) U.S. Cl. CPC H04L 9/0825; H04L 65/60; H04N 21/8358

(57) ABSTRACT

A method for secure digital cinema package delivery comprising a client-side device receiving an encrypted package with an applied digital watermark from a remote system. The client device can receive a public key associated with a paired display device previously transmitted to the system. The client device can receive an encrypted message corresponding to the package and display device, including encryption keys and timing parameters. The message can be encrypted using the public key of the display device. The client device can decrypt the message with a private key stored on the display device to extract the encryption keys to decrypt the package. The decrypted package can be used to enable presentation of the digital content on the display device.

### TECHNICAL FIELD

This document relates generally to digital cinema packages (DCPs) and, more specifically, to securely distributing a DCP over a network. An example network may include aspects such as a wireless network, and some examples may include internet and/or satellite communications.

### BACKGROUND

Digital Cinema Packages (DCPs) are digital files that can be used to store and distribute feature films. DCPs provide a format including several elements to accommodate digital cinema and other large-scale screenings. Generally, a DCP will include a digital version of a film bundled with several separate files that can be optionally encrypted, e.g., including picture elements, sound elements, subtitles, and metadata. Digital distribution and exhibition of feature films can be advantageous over traditional film reels, including easier and cheaper duplication and distribution, consistent high image and sound quality, and flexibility in formatting and display. However, certain digital techniques can be susceptible to unauthorized copying and piracy if the digital files are not securely distributed and if the digital files are retained by an exhibitor after an intended time frame for the digital movie to be shown.

### SUMMARY

This document describes a method for secure delivery and playback of digital cinema packages (DCPs) to a paired display device. A client-side content delivery device can receive an at least partially encrypted DCP from a remote digital content delivery system. For example, the DCP can include a digital watermark, e.g., applied by the remote digital content delivery system. The client-side content delivery device can also receive a public key associated with a first display device that was previously transmitted to the remote digital content delivery system.

The client device can then receive an at least partially encrypted Key Delivery Message (KDM) corresponding to the at least partially encrypted DCP and first display device. For example, components included in the KDM, e.g., a content encryption key (CEK) and at least one playback timing parameter, can be encrypted using the public key of the first display device. The client device can decrypt the KDM using a private key stored on the second display device, extract the CEK from the decrypted KDM, then at least partially decrypt the DCP, e.g., in decrypting one or more individual essence files included in the DCP, using the extracted CEK. The at least partially decrypted DCP can be used to present the digital movie on the display device based on the at least one playback timing parameter, such as a time frame which the movie can be exhibited.

The DCP can include a plurality of compositional variations of a digital movie, and each compositional variation can correspond to a type of display device e.g., for a display device having a specified resolution, audio codec, or other specifications. Here, each with playback quality attribute can correspond to the type of display device. The client device can receive a plurality of at least partially encrypted KDMs (e.g., including encrypted CEKs) corresponding with respective paired display devices, decrypt them, and present the DCP using the quality attributes associated with each respective display device.

In an example, a public key and private key, each associated with an individual display device, can be a cryptographically related key pair having been generated using an asymmetric algorithm (e.g., a hashing algorithm), using a one-way function. Here, an individual public key cannot be derived from its corresponding private key of the related key pair, and the private key can likewise not be derived from its corresponding public key. Once encrypted using the public key, the KDM can only be decrypted by the private key corresponding to the public key, and the KDM cannot be decrypted using the public key with which it was encrypted. This can help ensure the KDMs and enclosed CEKs are securely bound to the appropriate display device and prevents unauthorized decryption of the DCP.

Each of the non-limiting examples described herein can stand on its own, or can be combined in various permutations or combinations with one or more of the other examples.

This Summary is intended to provide an overview of the subject matter of the present patent application. It is not intended to provide an exclusive or exhaustive explanation of the invention. The detailed description is included to provide further information.

### BRIEF DESCRIPTION OF THE DRAWINGS

In the drawings, which are not necessarily drawn to scale, like numerals can describe similar components in different views. Like numerals having different letter suffixes can represent different instances of similar components. Some embodiments are illustrated by way of example, and not limitation, in the figures of the accompanying drawings in which:

FIG. 1 illustrates an example of a digital DCP system.

FIG. 2 depicts examples of a DCP and a KDM for receipt via a client-side digital content delivery device at an exhibitor location.

FIG. 3 is a flowchart describing a process of a media box in handling a DCP.

FIG. 4 is a flowchart describing a process of a media box in handling a CPL to initiate playback of a digital movie of a DCP.

FIG. 5 is a flowchart showing a method of secured distribution of a digital cinema package (DCP).

FIG. 6 shows an example system for distributed DCP over internet, according to some example embodiments.

FIG. 7 is a block diagram of a client-side content delivery device, according to some example embodiments.

FIG. 8 shows communications within a system for distributed DCP over internet, according to some example embodiments.

FIG. 9 shows communications within an exhibitor location for distributed DCP over internet, according to some example embodiments.

FIG. 10 is a block diagram illustrating components of an example of a machine.

### DETAILED DESCRIPTION

Disclosed are systems, methods, and computer-readable storage media for securely distributing digital cinema packages (DCPs) over a wireless network. Generally, digital movies can be delivered to an exhibitor location (e.g., a movie theater) as a DCP in a physical format. For example, a digital movie can be transcoded into a DCP and stored onto a physical storage device, such as a CRU drive, which can be delivered to a movie theater in a rugged shipping case, forming a DCP kit. This process provides a way to control and track the digital copies of the movies since playback of a DCP can be restricted to its respective physical storage device. While the technique of storing and distributing DCPs as physical storage devices can be beneficial in terms of security, such a technique can be challenging since the process of creating and delivering the DCPs is time-consuming and expensive. Also, the process of preparing and shipping physical DCP kits can complicate prompt and timely distribution of digital movies at a large scale. Further, DCPs delivered on physical media such as hard drives, tapes, or optical discs, can be lost or stolen without downstream control from a distributor.

Alternatively, DCPs can be stored and distributed as digital files over a network, e.g., the Internet. A challenge associated with the digital distribution of movies is the unauthorized duplication or piracy of these films. If digital movies are not properly secured, they can be more vulnerable, as compared to physical DCP kits, to illegal replication and unauthorized viewing. One approach to securing digital DCPs is to incorporate digital rights management (DRM) technology into digital movie content. DRM technology can help provide that the digital movie content is properly authenticated, encrypted, stored, and access is restricted to authorized users. Additionally, DRM technology can be used to enforce usage limitations on digital media, such as limiting the number of devices or times a movie can be viewed. DRM technology can involve multiple layers of encryption, digitally signing content, as well as periodic authentication to ensure that content has not been modified or stolen. DRM can be used to track usage of DCP files, allowing for better accounting and tracking of revenue from copyrighted content. While an approach involving DRM technology can help mitigate a concern of unauthorized distribution of DCPs, certain DRM approaches can be challenging or unfeasible due to the cost of such solutions, lack of compatibility with existing systems, and complexity of implementation at a large scale. For example, certain approaches involving DRM technology can require the exhibitor to retrofit specialized hardware, such as set-top boxes, decryption systems, authentication tokens, and other specialized devices to receive and access DCPs. Thus, efforts to regulate and secure delivery and storage of DCPs via DRM technology can place a burden of adoption on the exhibitor, rather than the distributor whose interests the DRM technology is primarily protecting. The present inventors have recognized a need for a more centralized, top-down approach for securely storing and delivering DCPs over a network, and in some examples over a wireless network.

This disclosure involves encryption and decryption of a DCP or its contents, leveraging decryption at least partially via an internally stored private key of an individual display device, such as a projector. Encryption can involve, e.g., by the distributor, watermarking of the video, encrypting the digital movie content using a common encryption key (CEK), and generating unique or different key delivery messages (KDMs) for each authorized display device, each KDM at least partially encrypted with an individual display device's public key. The exhibitor's playback server or media box can include, have access to, or facilitate use of a private key to decrypt the KDM and obtain the CEK included therein. The CEK can then be used to decrypt the movie content for display. Such architecture allows the distributor to securely deliver the same movie content to multiple exhibitors, each having multiple display devices, while preventing access by unauthorized third parties.

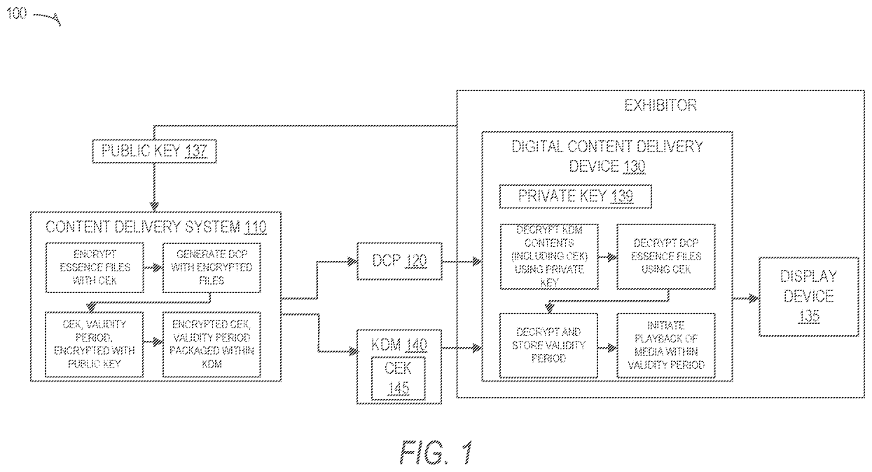

FIG. 1 illustrates an example of a digital DCP system. Generally, a digital DCP system 100 can facilitate creation, delivery, and screening of a DCP between a distributor and an exhibitor. The digital DCP system 100 can include a digital content delivery system 110, e.g., controlled or operated by a distributor such as a movie studio, a broadcast network, a content distribution network, or another content service provider. The digital content delivery system 110 can produce or facilitate access to a DCP 120 including essence files of a digital movie. The essence files can include video/audio essence files as well as subtitle, metadata, or other text-based files. The DCP 120 or an individual essence file thereof can be encrypted, e.g., by the distributor with a Content Encryption Key (CEK) generated for an individual DCP 120. For example, the DCP 120 can be “at least partially encrypted”, meaning herein that at least one essence file included in the DCP 120 is encrypted, several essence files included in the DCP 120 are encrypted, or the DCP 120 itself is encrypted. In an example where the DCP 120 itself is encrypted, a DCP manifest file can be accessible separately from the essence files and the DCP manifest file can be accessible without decryption of the DCP 120. Also herein, “encrypted DCP” need not necessarily mean that the entire DCP 120 is encrypted and rather generally refers to a DCP where certain files included for playback of a digital movie are individually encrypted or otherwise effectively encrypted. For example, the CEK can be based on a unique Key Identifier (KID) associated with the DCP 120. Alternatively or additionally, the DCP 120 can be encrypted using a Multiple Encryption Key or Key Encryption Key technique. In an example, the digital content delivery system 110 can generate a DCP including the essence files, each encrypted with the CEK. Here, the CEK can be a random number or alphanumeric key which is only known to the digital content delivery system 110. In an example, the digital movie can be watermarked by the digital content delivery system 110 or otherwise watermarked by the distributor before distribution. For example, a unique watermark can be embedded into the DCP 120 to identify the customer or recipient, e.g., a theater. This watermark can be used to help track and identify unauthorized use or distribution of the DCP 120.

In an example, the exhibitor can facilitate access of the digital content delivery system 110 to a public key 137 of a display device 135. Here, the public key 137 can be included in a cryptographically related key pair, the key pair having been generated using an asymmetric algorithm (e.g., a hashing algorithm), including a one-way function. For example, the asymmetric algorithm can facilitate secure access of data via a private key 139, e.g., by the display device 135, in a manner inaccessible to the public, and the generation of a visible identifier (e.g., the public key 137) associated therewith. Here, the public key 137 can be based, at least in part, on one of the parameters (e.g., device ID, Exhibitor ID, or theater ID) associated with the display device 135. As described further below with respect to the KDM 140, the public key 137 can effectively be used to encrypt the CEK 145 and the associated parameters (e.g., device ID, Exhibitor ID, or theater ID) using a cryptographic algorithm (e.g., Advanced Encryption Standard (AES) or RSA) to further facilitate secure delivery of the DCP. Here, an individual public key 137 cannot be derived from its corresponding private key 139 of the cryptographically related key pair, and the private key 139 can likewise not be derived from its corresponding public key 137. The exhibitor can facilitate delivery of the public key 137 to the digital content delivery system 110 via email, over a network (e.g., the internet), or via a physical medium such as a secure USB device.

In an example, the digital content delivery system 110 can also produce or facilitate access to a KDM 140 including the CEK 145 and at least one playback timing parameter of a digital movie of the DCP 120. For example, the at least one playback timing parameter can include a playback validity period, a start date/time, an end date/time, or a frequency at which the digital movie is scheduled to play. In an example, the KDM 140 can be at least partially encrypted, e.g., by the content delivery system 110, before delivery to a content delivery device 130, e.g., at least partially encrypted using the public key 137 of the individual display device 135, on which playback of the DCP 120 is intended by the distributor. For example, the KDM 140 can be “at least partially encrypted”, meaning herein that at least component (e.g., a CEK, a validity period/time window, an authorized CPL, etc.) included in the KDM 140 is encrypted, several components included in the KDM 140 are encrypted, or the KDM 140 itself is encrypted. In an example where the KDM 140 itself is encrypted, at least one component (e.g., a digital signature or authorized CPL) can be accessible separately from other effectively encrypted components and without decryption of the KDM 140. Also herein, “encrypted KDM” need not necessarily mean that the entire KDM 140 is encrypted and rather generally refers to a KDM where certain files included for playback of a digital movie, such as for decryption of a DCP 120, are individually encrypted or otherwise effectively encrypted.

Generally, a KDM 140 can correspond uniquely or 1-to-1 with an individual display device 135 or an individual client-side content delivery device 130, and in an example a plurality of KDMs 140 can each facilitate access to a single common DCP 120. Herein, a client-side digital content delivery device 130 can refer to a media box corresponding with a projector, a media server, or a software application running on a PC or any other type of computing device. In an example, the digital content delivery system 110 can produce or facilitate access to the plurality of KDMs 140, each corresponding to one of a plurality of display devices 135. Here, each KDM can include a common CEK 145 corresponding to the single common DCP 120, and each KDM can be encrypted using the respective public key 137 of a corresponding display device 135. Thus, each display device can share the single common DCP 120, including common encryption via a common CEK 145, while including unique encryption via a unique KDM intended exclusively for an individual display device 135.

The at least partially encrypted DCP 120 and the at least partially encrypted KDM 140 can be distributed, via the content delivery system 110, to a client-side device at an exhibitor location. For example, the at least partially encrypted DCP 120 and at least partially encrypted KDM 140 can be received by a theater management system (TMS) or can be received at a client-side content delivery device 130. The content delivery device 130 can receive the at least partially encrypted DCP 120 and the at least partially encrypted KDM 140 and facilitate decryption, e.g., of the essence files of the DCP 120. Generally, the content delivery device 130 can use the CEK 145 to decrypt the DCP 120 and use the one or more playback timing parameters of the KDM 140 to enable playback of the DCP 120 for a specified period of time. Here, the content delivery device 130 can decrypt the KDM 140 using the private key 139, and the CEK 145 can be used by the content delivery device 130 to decrypt the DCP 120.

In an example, the private key 139 can be stored in secure memory of the client-side content delivery device 130. Additionally or alternatively, the private key 139 can be stored on the display device 135 and accessible via the content delivery device 130. For example, the private key 139 can be stored on a Trusted Platform Module (TPM) secure processor module (e.g., an Application Specific Integrated Circuit (ASIC)) of the individual display device 135. Here, the private key 139 can be protected from access by the exhibitor or other parties. In an example, the private key 139 can identify the display device 135, e.g., outputting a signature to indicate that the display device 135 is genuine (e.g., as part of a signature-verification process).

In an example, once the essence files of the DCP 120 are decrypted or otherwise accessible, the display device 135 can render and output the essence files for playback of the digital movie on the display device 135. For example, the display device 135 can include a projector, a monitor, a television, or any other device for displaying video data. Generally, the display device 135 can play back the essence files as long as a valid KDM 140 for the display device 135 has been provided via the at least one playback timing parameter. However, if the KDM 140 is discovered to have been tampered with or if the DCP 120 has been tampered with (e.g., causing it to no longer correspond with the KDM 140), the display device 135 can stop or refuse playback.

The display device 135 can include a timing function (in the form of a secure clock or other timing mechanism) configured for tracking playback timing parameters. For example, the display device 135 can use the timing function to track, in reference to the one or more playback timing parameters of the KDM 140, when or for how long the DCP 120 can be properly rendered. Here, the CEK and the playback timing parameters can correspond to the KDM 140, the KDM 140 being bound to the display device 135, and the KDM 140 being deliverable in a single download (e.g., via an encrypted pathway). For example, if the CEK 145 is bound to the KDM 140, any individual/unauthorized attempt to modify the DCP 120 can be detected and/or prevented (e.g., by not releasing a valid matching KDM 140).

In an example, the digital content delivery system 110 can generate or receive (from an authorized third party) an audit log derived from one or more individual display devices 135, such as a manufacture log, a distributor log, an exhibitor log, or an enforcement log. The audit log can provide evidence that a digital movie was played back on the display device 135, at a particular exhibitor location. Here, the audit log can include evidence that the KDM 140 was properly decrypted with the private key 139 associated with its corresponding public key 137. In an example, the digital content delivery system 110 can use the audit log to audit playback by each display device 135 and to detect when a KDM 140 was misused or when the play period of the KDM 140 may have expired.

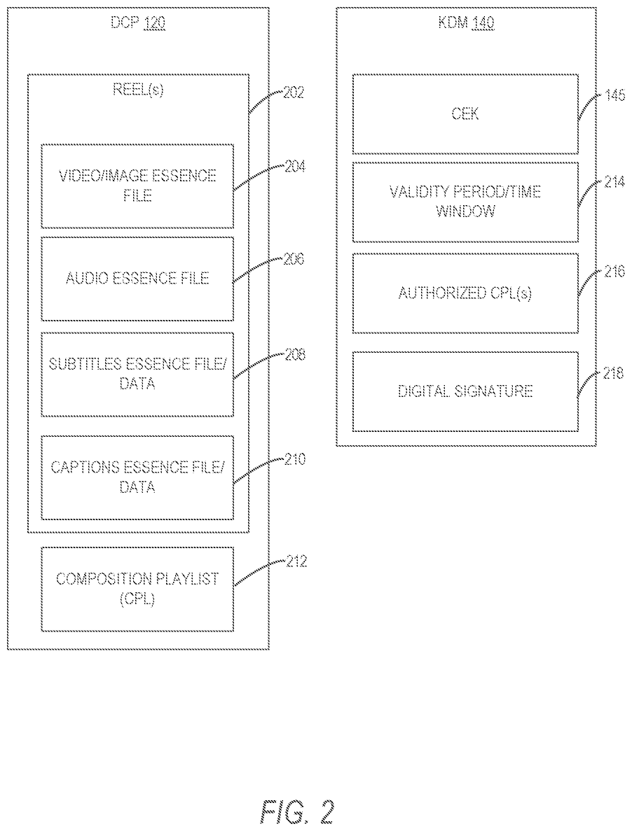

FIG. 2 depicts examples of a DCP and a KDM for receipt via a content delivery device at an exhibitor location. The DCP 120 can include one or more reels 202, and an individual reel 202 can include a video/image essence file 204, an audio essence file 206, a subtitles essence file or subtitle data 208, and a captions essence file or captions data 210. The DCP 120 can also include a composition playlist (CPL) 212, which can correspond with one or more individual reels 202. The CPL 212 can include a list of files or elements 204, 206, 208, 210 and operations to be performed in constructing a distribution format presentation. Further, the CPL 212 can specify playback quality attributes, e.g., including at least one of a specified picture resolution or a specified audio compression format. For example, the CPL 212 can indicate that the picture resolution should be 2K, 4K, 6K, 8K, or any other suitable resolution. The CPL can also indicate that the audio compression format should be 5.1 channel, or, that the audio compression format should be 7.1 channel, or such as Dolby Digital, Dolby TrueHD, Dolby ATMOS, DTS, DTS-HD. In an example, the CPL 212 can specify a picture resolution or an audio format that corresponds with operating parameters a display device corresponding with the KDM, such as corresponding with operating parameters of the display device including the private key with which the KDM is decrypted. In various embodiments, a CPL 212 can include an ordered list of one or more sequences, which can in turn reference one or more elements or one or more tracks. For example, the CPL 212 can include a defined sequence of one or more images, subtitles, captions, audio, or a combination of these. Each image, subtitle, caption, or audio element can be referenced individually, or as an item in a track, which is a composite of one or more of elements 204, 206, 208, and 210. A track can include temporal and other information, which, when combined with the element referenced by the track, can be used to compose the presentation.

The KDM can include the CEK 145, a validity period or time window 214, one or more authorized CPLs 216, and a digital signature 218. The validity period can be a time window with a start and/or end date/time. An authorized CPL 216 can be a CPL previously verified by the distributor, which can be the same or different from the CPL 212 stored in the DCP 120. The digital signature can include data which is derived from or related to the CEK 145 or the one or more authorized CPLs 216. For example, the digital signature can include a signature generated using a key associated with the CEK 145.

In an example, a single KDM 140 is provided that can unlock multiple DCP reels 202, or multiple DCP reels 202 can be unlocked with a single CEK 145. In the former case, the digital signature 218 can be generated using a single CEK 145 and the one or more authorized CPLs 216 can include a CPL associated with each reel 202. In the latter case, the digital signature 218 can be generated using the single CEK 145 and the one or more of authorized CPLs 216 can include a single authorized CPL 216 and a reference for each reel associated with the authorized CPL 216.

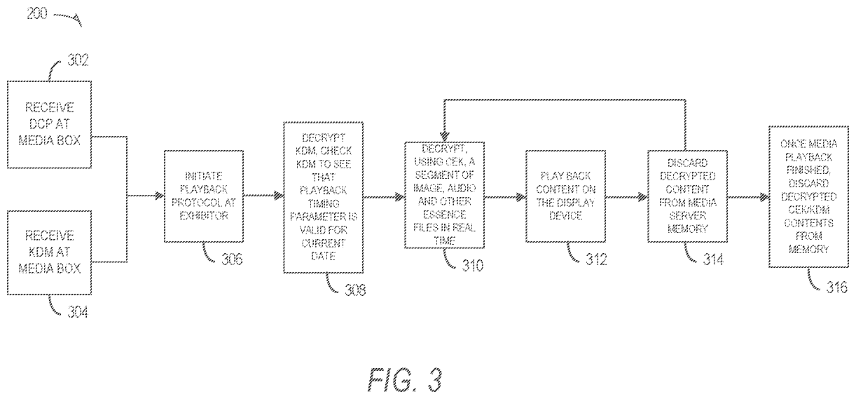

FIG. 3 is a flowchart describing a process of a media box in handling a DCP. For example, the media box can be included in the content delivery device 130 of FIG. 1. In an example, a single media box can facilitate playback of a DCP on a plurality of display devices. Also, an exhibitor location can include a plurality of media boxes, each configured for accessing a common DCP, e.g., via different received KDMs. At 302, the media box can receive a DCP and at 304, the media box can receive a KDM corresponding to the received DCP. At 306, the exhibitor can initiate a playback protocol, e.g., manually or via a theater management system (TMS). At 308, the KDM or content included in the KDM can be decrypted, e.g., using a private key of a corresponding display device for which the KDM was intended by the distributer. Here, the KDM can be analyzed to ensure a playback timing parameter included on the KDM is valid for a current date. For example, if the playback timing parameter is invalid, the media box can cease operations in decrypting the DCP. Once the KDM is decrypted, the CEK included therein can be accessible by the media box. At 310, the CEK can be used to decrypt a segment of image/video, audio, or other essence files of the DCP in real time. Herein, “real time” means without buffering or caching the content (e.g., frames of an image/video file) prior to playback via a display device. In an example, essence files corresponding with only a portion of the digital movie can be available for decryption and downstream essence files can be restricted from decryption until needed to continue playback of the digital movie. Such piecewise decryption of the DCP can further provide security, since if the media box was stolen or otherwise tampered with, only a portion of the digital movie would be rendered for playback and the other portions of the movie could remain secure. In an example, the portion of the digital movie can be shorter than the full length of the movie, such as, but not limited to, only a fraction or section of the digital movie. For example, the portion of the digital movie be shorter than 20 minutes, e.g., shorter than 5 minutes or even 3 minutes. At 312, the media box can facilitate playback of the portion of the digital movie on the display device, which can be e.g., physically, communicatively coupled to the media box. At 314, the image, audio, and other essence files of forming the portion of the digital movie can be discarded from server memory of the media box, and operations 310, 312, and 314 can be repeated for subsequent portions of the digital movie. At 316, once the media playback is finished, the decrypted CEK and KDM can be discarded from the server memory of the media box, e.g., to restrict the media box from multiple viewings of the DCP per a single KDM. In another example, the DCP and KDM can provide for a limited number of showings of the digital movie per received KDM, e.g., less than five showings before the decrypted CEK and KDM contents are discarded from the server memory of the media box.

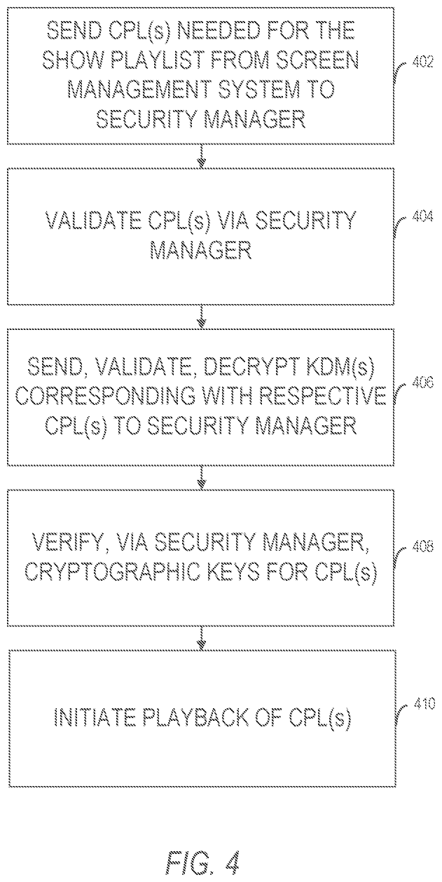

FIG. 4 is a flowchart describing a process of a media box in handling a CPL to initiate playback of a digital movie of a DCP. At 402, one or more CPLs included in a DCP or a KDM can be sent or distributed to a security manager, e.g., included in a media box or a TMS at the exhibitor location. At 404, the security manager can validate the one or more CPLs, e.g., by comparison with a previously stored distributor issuer certificate or another authenticated certificate, and determine whether use of the one or more CPLs is valid for the media box. At 406, KDMs corresponding with the one or more CPLs can be validated, decrypted, and sent to the security manager. At 408, cryptographic keys corresponding with the one or more CPLs (e.g., necessary for access to the one or more CPLs) can be verified via the security manager. At 410, once the one or more CPLs and corresponding KDMs are validated and the cryptographic keys are verified, at least one of the security manager, the media box, or the TMS can initiate playback of the one or more CPLs.

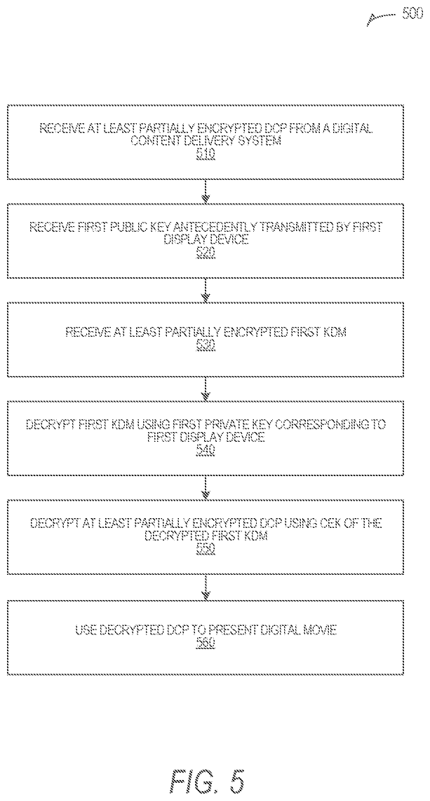

FIG. 5 is a flowchart showing a method of secured distribution of a digital cinema package (DCP).

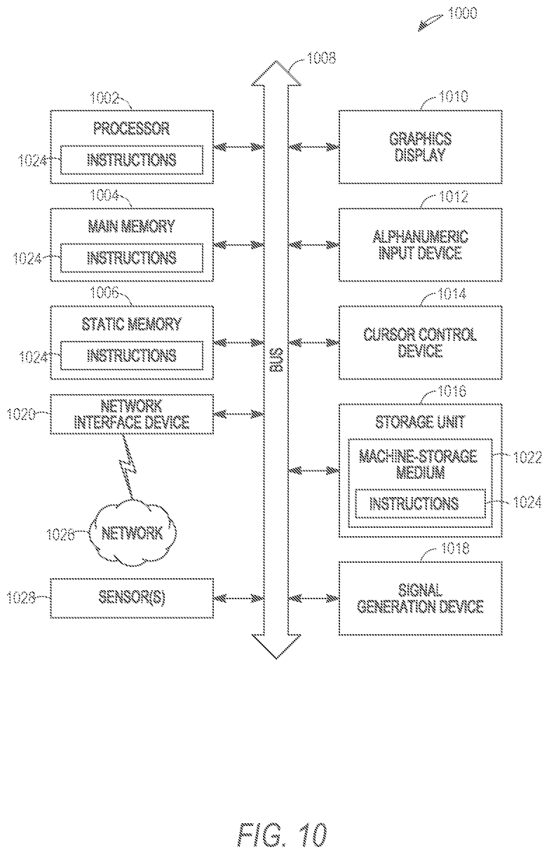

FIG. 5 is a flowchart showing a technique 500 of secured distribution of a digital cinema package (DCP). The technique 500 may be implemented using one or more devices or systems described herein, such as the processor of FIG. 10 or the system 100 of FIG. 1.

The technique 500 includes an operation 510 to receive an at least partially encrypted DCP from a digital content delivery system. For example, the digital content delivery system can be remote to the client-side content delivery device. The at least partially encrypted DCP can include a first persistent unique digital watermark, e.g., antecedently applied to the at least partially encrypted DCP by the digital content delivery system. In an example, the DCP can include a first compositional variation of the digital movie. Here, the first compositional variation can correspond, e.g., uniquely to an individual KDM. For example, the first compositional variation can include first playback quality attributes such as a specified picture resolution or a specified audio compression format.

The technique 500 includes an operation 520 to receive a first public key antecedently transmitted by first display device. The first public key can correspond with a first display device paired to the client-side content delivery device, and the first public key can be transmitted from the first display device. Also, the first public key can be otherwise transmitted by the exhibitor, e.g., via an online messaging platform or email.

The technique 500 includes an operation 530 to receive an at least partially encrypted first KDM. For example, the at least partially encrypted first KDM can correspond with the at least partially encrypted DCP. The at least partially encrypted first KDM can include or use a content encryption key (CEK) and at least one playback timing parameter of the digital movie. Also, the at least partially encrypted first KDM encrypted with a first public key corresponding with the first display device.

The technique 500 includes an operation 540 to decrypt the first KDM using a first private key corresponding to first display device. In an example, the first public key and the first private key are a pair of related keys generated using an asymmetric key algorithm including at least one one-way function. Here, the first KDM cannot be decrypted using the first public key and the first private key and the first public key cannot be derived from each other.

The technique 500 includes an operation 550 to decrypt at least partially encrypted DCP using a CEK of the decrypted first KDM.

The technique 500 includes an operation 560 to use the decrypted DCP to present the digital movie. For example, the digital movie can be presented according to the at least one playback timing parameter of the digital included in the first KDM. The at least one playback timing parameter of the digital movie can include a limited timeframe during which the digital movie can be presented.

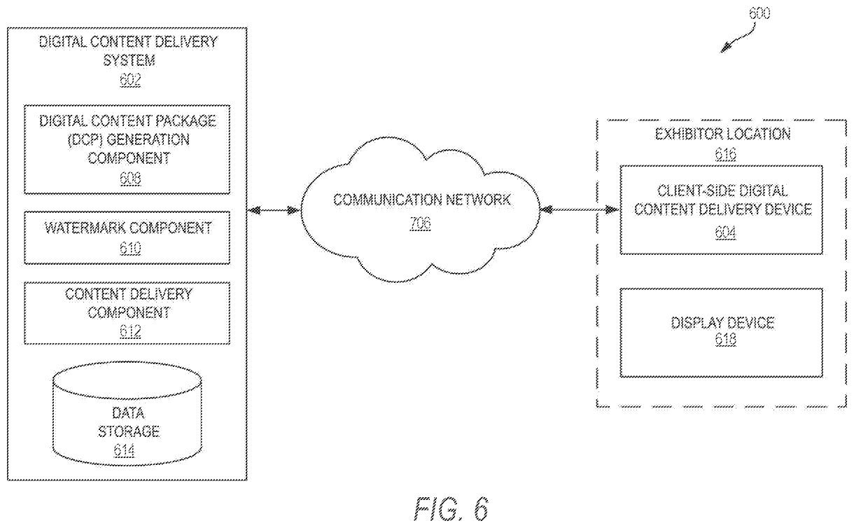

FIG. 6 shows an example system 600 for distributed DCP over internet, according to some example embodiments. As shown, multiple devices (e.g., digital content delivery system 602 and client-side content delivery device 604) are connected to a communication network 606 and configured to communicate with each other through use of the communication network 606. The communication network 606 is any type of network, including a local area network (LAN), such as an intranet, a wide area network (WAN), such as the internet, or any combination thereof. Further, the communication network 606 can be a public network, a private network, or a combination thereof. The communication network 606 is implemented using any number of communication links associated with one or more service providers, including one or more wired communication links, one or more wireless communication links, or any combination thereof. Additionally, the communication network 606 is configured to support the transmission of data formatted using any number of protocols.

Multiple computing devices can be connected to the communication network 606. A computing device is any type of general computing device capable of network communication with other computing devices. For example, a computing device can be a personal computing device such as a desktop or workstation, a business server, or a portable computing device, such as a laptop, smart phone, or a tablet personal computer (PC).

To facilitate communication with other computing devices, a computing device includes a communication interface configured to receive a communication, such as a request, data, and the like, from another computing device in network communication with the computing device and pass the communication along to an appropriate component running on the computing device. The communication interface also sends a communication to another computing device in network communication with the computing device.

As shown, the digital content delivery system 602 communicates with a client-side content delivery device 604 located at an exhibitor location 616. The client-side content delivery device 604 is connected to a display device 618 located at the exhibitor location 616. Although the shown system 600 includes only one exhibitor location 616, client-side content delivery device 604 and display device 618, this is just for ease of explanation and is not meant to be limiting. The system 600 can include any number of exhibitor locations 616, client-side content delivery devices 604 and display devices 618. Accordingly, the digital content delivery system 602 can communicate with any number of client-side content delivery devices 604 located at various exhibitor locations 616 to provide a DCP. Similarly, an exhibitor location 616 can include multiple client-side content delivery devices 604 and/or display devices 618.

The digital content delivery system 602 is one or more computing devices configured generate DCPs of digital movies and provide the DCP to an exhibitor location 616 over the internet (e.g., via the communication network 606). A DCP is a collection of digital files used to store and convey digital cinema audio, image, and data streams. For example, a DCP consists of all the files that make up a digital film, such as the picture, sound, subtitles, and related information that ensures that the digital movie is presented correctly.

The digital content delivery system 602 includes a DCP generation component 608 configured to generate a DCP of a digital movie. For example, the DCP generation component transcodes the digital movie based on the standardized DCP format. The DCP generation component 608 can store a generated DCP in the data storage 614, where it can be accessed by the other components of the digital content delivery system 602.

The watermark component 610 applies a digital watermark (e.g., forensic watermark) to a copy of the DCP that will be transmitted to an exhibitor location 616. A digital watermark is a type of marker that is embedded into audio, video and/or image data. The digital watermark can include data used to identify the specific copy of the DCP to which it is applied. For example, the watermark component 610 can apply a digital watermark to the DCP that includes a unique identifier that identifies the exhibitor, exhibitor location 616, and/or client-side content delivery device 604 to which the DCP is being transmitted. Accordingly, the DCP of a digital movie provided to different exhibitor locations 616 can be embedded with different digital watermarks that identify the specific exhibitor, exhibitor location 616, and/or content delivery device 604. If a misused version of the digital movie is found, such as a pirated version of the digital movie, the digital watermark applied to the digital movie can be used to identify the exhibitor, exhibitor location 616 and/or content delivery device 604 to which the DCP of the digital movie was provided.

The unique identifiers associated with each exhibitor location 616 and/or client-side content delivery device 604 can be stored in the data storage 614. Accordingly, the watermark component 610 can access the unique identifier for the exhibitor location 616 and/or client-side content delivery device 604 from the data storage 614. The watermark component 610 can then use the unique identifier to apply the digital watermark to the DCP.

The watermark component 610 can provide the copy of the DCP that has been embedded with the digital watermark to the content delivery component 612. The content delivery component 612 transmits the DCP to the client-side content delivery device 604 via the communication network 606. In this way, the digital content delivery system 602 can distribute DCPs to multiple remote exhibitor locations 616 via a communication network 606 such as the internet rather than through the traditional method of shipping physical copies of the DCP.

In some embodiments, the content delivery component 612 can encrypt the DCP prior to transmission to the client-side content delivery device 604. For example, the content delivery component 612 can encrypt the DCP using an encryption key or algorithm that results in an at least partially encrypted DCP that can be decrypted using a corresponding key or algorithm by the receiving client-side content delivery device 604. The key or algorithm used to decrypt the DCP can be allocated to the client-side content delivery device 604 prior to transmission of the DCP. For example, the key or algorithm can be provided to the client-side content delivery device 604 as a key delivery message (KDM).

The client-side content delivery device 604 is a physical hardware device that is configured to interface with the communication network 606 to communicate with remote computing systems. The client-side content delivery device 604 can also be physically connected to a display device 618 using a physical connector such as a cable, and cause presentation of a DCP by the display device 618. For example, the client-side content delivery device 604 can be a set-top box with internet connection capabilities that also include appropriate ports to be physically connected to a display device 618 (e.g., digital movie projector) located at an exhibitor location 616 (e.g., movie theater).

The client-side content delivery device 604 receives the DCP from the digital content delivery system 602 via the communication network 606 and stores the DCP in a data storage from where it can be accessed. For example, the client-side content delivery device 604 can access the DCP from the data storage to cause presentation of the DCP by a display device 618 that is physically paired to the client-side content delivery device 604. A display device 618 can be any type of device that is configured to present a digital movie, such as a digital projector, television, and the like. The display device 618 can be paired to the client-side content delivery device 604 via a physical connector, such as a cable.

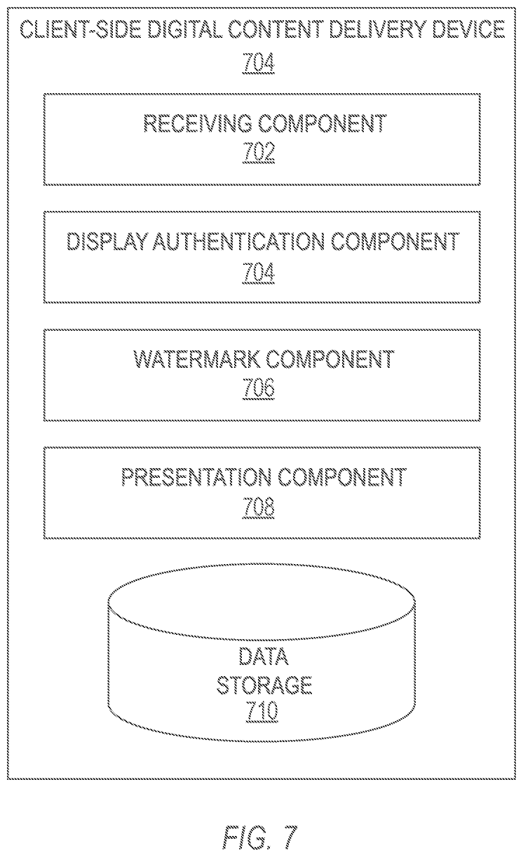

The client-side content delivery device 604 can be configured to perform several functions to provide security against misuse of the digital movie. For example, the client-side content delivery device 604 can be configured to decrypt the DCP prior to presentation, apply a client-side digital watermark that includes session specific data, as well as ensure that the display device 618 is an authorize display device 618. The functionality of the client-side content delivery device 604 is described in greater detail in relation to FIG. 7.

FIG. 7 is a block diagram of a client-side content delivery device 604, according to some example embodiments. To avoid obscuring the inventive subject matter with unnecessary detail, various functional components (e.g., modules) that are not germane to conveying an understanding of the inventive subject matter have been omitted from FIG. 7. However, a skilled artisan will readily recognize that various additional functional components can be supported by the client-side content delivery device 604 to facilitate additional functionality that is not specifically described herein. Furthermore, the various functional modules depicted in FIG. 7 can reside on a single computing device or can be distributed across several computing devices in various arrangements such as those used in cloud-based architectures.

As shown, the client-side content delivery device 604 includes a receiving component 702, a display authentication component 704, watermark component 706, a presentation component 708 and a data storage 710. The receiving component 702 is configured to receive a DCP from a digital content delivery system 602. The receiving component 702 can store the received DCP in the data storage 710 where it can be accessed by the other components of the client-side content delivery device 604.

The display authentication component 704 ensures that the display device 618 paired to the client-side content delivery device 604 is authorized to operate with the client-side content delivery device 604. As a security feature, each client-side content delivery device 604 can be restricted to use with one or more authorized display devices 618. For example, each client-side content delivery device 604 allocated to an exhibitor location 616 can be configured to operate with a specified set of display devices 618, such as a set of digital projectors located at the exhibitor location 616. Each client-side content delivery device 604 can be loaded with a set of one or more authenticated unique identifiers that identify the authorized display devices 618. For example, the authorized unique identifiers can be stored in the data storage 614.

The display authentication component 704 uses the authorized unique identifiers to ensure that the display device 618 is authorized for use with the client-side content delivery device 604. For example, prior to initiating presentation of a DCP, the display authentication component 704 accesses a unique device identifier from the display device 618 paired to the client-side content delivery device 618. The display authentication component 704 can access the unique identifier by transmitting a request to the display device 618 for the unique identifier, which the display device 618 can return in response.

The display authentication component 704 uses the received unique identifier to determine whether the display device 618 is authorized for use with the client-side content delivery device 604. For example, the display authentication component 704 compares the unique device identifier received from the paired display device 618 to the authenticated unique identifiers stored in the data storage 614.

If the unique identifier accessed from the paired display device 618 does not match one of the authorized unique identifiers, the display authentication component 704 determines that the display device 618 is not authorized for use with the client-side content delivery device 604. In this type of situation, the display authentication component 704 can prohibit the client-side content delivery device 604 from causing presentation of the digital movie by the display device 618.

Alternatively, if the unique identifier accessed from the paired display device 618 matches one of the authorized unique identifiers, the display authentication component 704 determines that the display device 618 is authorized for use with the client-side content delivery device 604. In this situation, the display authentication component 704 can communicate with the other components of the client-side content delivery device 604 to cause presentation of the digital movie by the display device 618. For example, the display authentication component 704 can communicate with the watermark component 706 and/or the presentation component 708.

The watermark component 706 applies a client-side digital watermark to the digital movie prior to presentation of the digital movie by the display device 618. The client-side digital watermark can include session data that uniquely identifies the individual presentation of the digital movie. For example, the session data can include data identifying the day/time of presentation, the specific theater number, and the like.

The presentation component 708 causes presentation of the digital movie by the display device 618. For example, the presentation component 708 can stream the digital movie to the display device 618. The presentation component 708 can also decrypt the DCP if needed, such as by using a key delivery message (KDM).

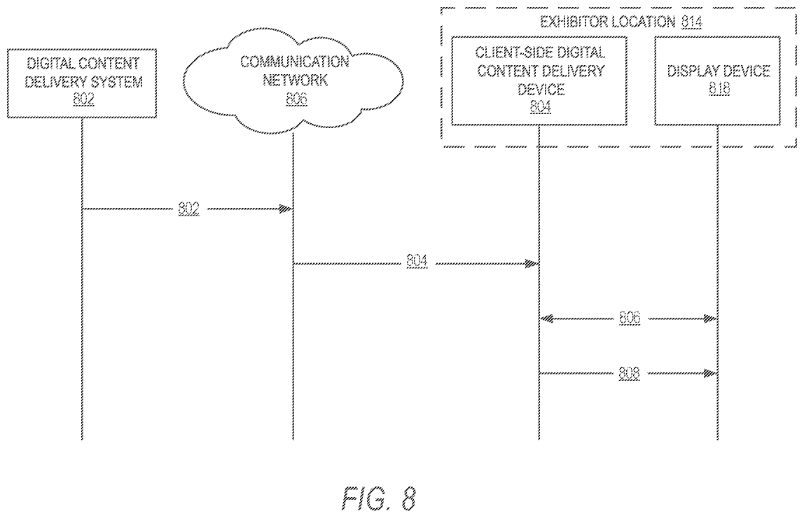

FIG. 8 shows communications within a system for distributed DCP over internet, according to some example embodiments. As shown, the digital content delivery system 602 provides a DCP to an exhibitor location 616 via a communication network 606. For example, the digital content delivery system 602 communicates 802 with the commination network 606 to cause the DCP to be transmitted 804 to the client-side content delivery device 604 located at the exhibitor location 616. As discussed previously, the DCP transmitted to the exhibitor location 616 can be encrypted and/or embedded with a digital watermark that identifies the exhibitor, exhibitor location 616, and/or the client-side content delivery device 604.

The client-side content delivery device 604 can use the received DCP to cause presentation of a digital movie by the display device 618. This can include decrypting the DCP and/or applying a client-side digital watermark to the DCP prior to causing presentation by the display device 618.

The client-side content delivery device 604 can also ensure that the display device 618 that is paired to the client-side content delivery device 604 is authorized to operate with the client-side content delivery device 604. For example, the client-side content delivery device 604 communicates 806 with the display device 618 (e.g., transmits a request to the display device 618 and receives a response to the request) to access a unique identifier for the display device. The unique identifier can be any type of identifier that uniquely identifies the display device 618, such as a serial number. The client-side content delivery device 604 compares the received unique identifier to a set of authorized unique identifiers to determine whether the display device 618 is authorized to operate with the client-side content delivery device 604. For example, the client-side content delivery device 604 determines whether the unique identifier received from the display device 618 matches one of the authorized unique identifiers stored by the display device 618.

In the event that the client-side content delivery device 604 determines the that the display device 618 is authorized to operate with the client-side content delivery device 604, the client-side content delivery device 604 can cause presentation of the digital movie by the display device 618. For example, the client-side content delivery device 604 can stream 808 video and audio data to the display device 618, which is presented by the display device 618.

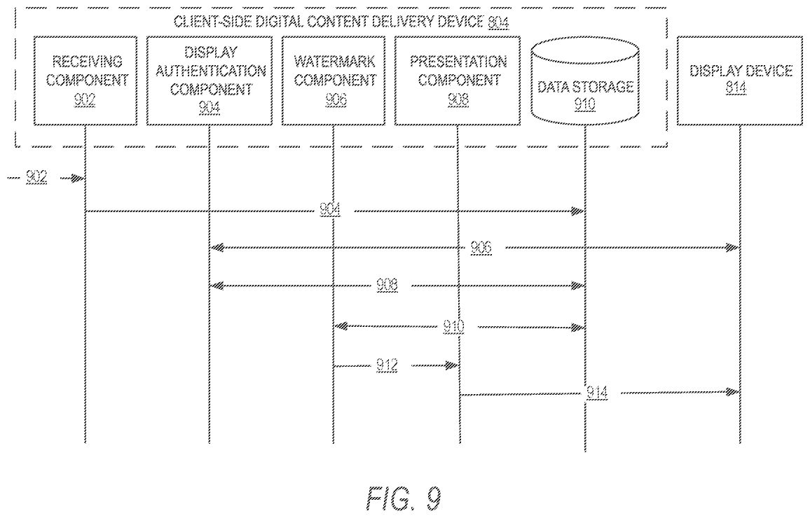

FIG. 9 shows communications within an exhibitor location for distributed DCP over internet, according to some example embodiments. As shown, the receiving component 702 of the client-side content delivery device 604 receives 902 a DCP. The DCP can be received from a digital content delivery system 602 via a communication network 606 such as the internet. The DCP can be encrypted and/or embedded with a digital watermark that identifies the exhibitor, exhibitor location 616, and/or the client-side content delivery device 604.

The receiving component 702 stores 904 the DCP in the data storage 710, where it can be accessed by the other components of the client-side content delivery device 604. For example, the DCP can be accessed from the data storage 710 to cause presentation of a digital movie by the display device 618. This can be performed in response to receiving a user input to cause presentation of the digital movie, such as a user using an input device (e.g., physical button, remote control, keyboard, etc.) of the client-side content delivery device 604 to cause presentation of the digital movie.

In response to receiving an input to present the digital movie, the display authentication component 704 communicates 906 with the display device 618 paired to the client-side content delivery device 604 to access a unique identifier of the display device 618. The display authentication component 704 also communicates 908 with the data storage 710 to access a set of authorized unique identifiers. The display authentication component 704 compares the unique identifier received from the display device 618 to the set of unique identifiers accessed from the data storage 710 to determine whether the display device 618 is authorized to operate with the client-side content delivery device 604. For example, the display authentication component 704 determines whether the unique identifier received from the display device 618 matches any of the authorized unique identifiers.

In the event that the display device 618 is authorized to operate with the client-side content delivery device 604, the watermark component 706 accesses 910 the DCP from the data storage 710 and applies a client-side digital watermark to a copy of the DCP. The client-side digital watermark can include session data describing the specific presentation of the digital movie, such as a day/time of the presentation, theater, and the like.

The watermark component 706 provides 912 the copy of the DCP embedded with the client-side digital watermark to the presentation component 708. In turn, the presentation component 708 causes presentation of the digital movie by display device 618. For example, the presentation component 708 streams 914 video and audio data to the display device 618, which is then presented by the display device 618.

FIG. 10 is a block diagram illustrating components of a machine 1000, according to some example embodiments, able to read instructions 1024 from a machine-storage medium 1022 (e.g., a non-transitory machine-storage medium, a machine-storage medium, a computer-storage medium, or any suitable combination thereof) and perform any one or more of the methodologies discussed herein, in whole or in part. Specifically, FIG. 10 shows the machine 1000 in the example form of a computer system (e.g., a computer) within which the instructions 1024 (e.g., software, a program, an application, an applet, an app, or other executable code) for causing the machine 1000 to perform any one or more of the methodologies discussed herein can be executed, in whole or in part. For example, the instructions 1024 can be processor executable instructions that, when executed by a processor of the machine 1000, cause the machine 1000 to perform the operations outlined above.

In various embodiments, the machine 1000 operates as a standalone device or can be communicatively coupled (e.g., networked) to other machines. In a networked deployment, the machine 1000 can operate in the capacity of a server machine or a client machine in a server-client network environment, or as a peer machine in a distributed (e.g., peer-to-peer) network environment. The machine 1000 can be a server computer, a client computer, a personal computer (PC), a tablet computer, a laptop computer, a netbook, a cellular telephone, a smartphone, a set-top box (STB), a personal digital assistant (PDA), a web appliance, a network router, a network switch, a network bridge, or any machine capable of executing the instructions 1024, sequentially or otherwise, that specify actions to be taken by that machine. Further, while only a single machine is illustrated, the term “machine” shall also be taken to include any collection of machines that individually or jointly execute the instructions 1024 to perform all or part of any one or more of the methodologies discussed herein.

The machine 1000 includes a processor 1002 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 1004, and a static memory 1006, which are configured to communicate with each other via a bus 1008. The processor 1002 can contain microcircuits that are configurable, temporarily or permanently, by some or all of the instructions 1024 such that the processor 1002 is configurable to perform any one or more of the methodologies described herein, in whole or in part. For example, a set of one or more microcircuits of the processor 1002 can be configurable to execute one or more modules (e.g., software modules) described herein.

The machine 1000 can further include a graphics display 1010 (e.g., a plasma display panel (PDP), a light emitting diode (LED) display, a liquid crystal display (LCD), a projector, a cathode ray tube (CRT), or any other display capable of displaying graphics or video). The machine 1000 can also include an alphanumeric input device 1012 (e.g., a keyboard or keypad), a cursor control device 1014 (e.g., a mouse, a touchpad, a trackball, a joystick, a motion sensor, an eye tracking device, or other pointing instrument), a storage unit 1016, an audio generation device 1018 (e.g., a sound card, an amplifier, a speaker, a headphone jack, any suitable combination thereof, or any other suitable signal generation device), and a network interface device 1020.

The storage unit 1016 includes the machine-storage medium 1022 (e.g., a tangible and non-transitory machine-storage medium) on which are stored the instructions 1024, embodying any one or more of the methodologies or functions described herein. The instructions 1024 can also reside, completely or at least partially, within the main memory 1004, within the processor 1002 (e.g., within the processor's cache memory), or both, before or during execution thereof by the machine 1000. Accordingly, the main memory 1004 and the processor 1002 can be considered machine-storage media (e.g., tangible and non-transitory machine-storage media). The instructions 1024 can be transmitted or received over the network 1026 via the network interface device 1020. For example, the network interface device 1020 can communicate the instructions 1024 using any one or more transfer protocols (e.g., Hypertext Transfer Protocol (HTTP)).

In some example embodiments, the machine 1000 can be a portable computing device, such as a smart phone or tablet computer, and have one or more additional input components (e.g., sensors 1028 or gauges). Examples of the additional input components include an image input component (e.g., one or more cameras), an audio input component (e.g., a microphone), a direction input component (e.g., a compass), a location input component (e.g., a global positioning system (GPS) receiver), an orientation component (e.g., a gyroscope), a motion detection component (e.g., one or more accelerometers), an altitude detection component (e.g., an altimeter), and a gas detection component (e.g., a gas sensor). Inputs harvested by any one or more of these input components can be accessible and available for use by any of the modules described herein.

### Executable Instructions and Machine-Storage Medium

The various memories (i.e., 1004, 1006, and/or memory of the processor(s) 1002) and/or storage unit 1016 can store one or more sets of instructions and data structures (e.g., software) 1024 embodying or utilized by any one or more of the methodologies or functions described herein. These instructions, when executed by processor(s) 1002 cause various operations to implement the disclosed embodiments.

As used herein, the terms “machine-storage medium,” “device-storage medium,” “computer-storage medium” (referred to collectively as “machine-storage medium 1022”) mean the same thing and can be used interchangeably in this disclosure. The terms refer to a single or multiple storage devices and/or media (e.g., a centralized or distributed database, and/or associated caches and servers) that store executable instructions and/or data, as well as cloud-based storage systems or storage networks that include multiple storage apparatus or devices. The terms shall accordingly be taken to include, but not be limited to, solid-state memories, and optical and magnetic media, including memory internal or external to processors. Specific examples of machine-storage media, computer-storage media, and/or device-storage media 1022 include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks. The terms machine-storage medium or media, computer-storage medium or media, and device-storage medium or media 1022 specifically exclude carrier waves, modulated data signals, and other such media, at least some of which are covered under the term “signal medium” discussed below. In this context, the machine-storage medium is non-transitory.

### Signal Medium

The term “signal medium” or “transmission medium” shall be taken to include any form of modulated data signal, carrier wave, and so forth. The term “modulated data signal” means a signal that has one or more of its characteristics set or changed in such a matter as to encode information in the signal.

### Computer Readable Medium

The terms “machine-readable medium,” “computer-readable medium” and “device-readable medium” mean the same thing and can be used interchangeably in this disclosure. The terms are defined to include both machine-storage media and signal media. Thus, the terms include both storage devices/media and carrier waves/modulated data signals.

The following, non-limiting examples, detail certain aspects of the present subject matter to solve the challenges and provide the benefits discussed herein, among others.

Example 1 is a method comprising: receiving, by a client-side content delivery device, an encrypted digital cinema package (DCP) for a digital movie, the at least partially encrypted DCP received from a digital content delivery system that is remote to the client-side content delivery device, the at least partially encrypted DCP including a first persistent unique digital watermark antecedently applied to the at least partially encrypted DCP by the digital content delivery system; receiving from the digital content delivery system, a first public key antecedently transmitted to the digital content delivery system by a first display device paired to the client-side content delivery device, the first public key corresponding with the first display device; receiving, by the client-side content delivery device, an encrypted first Key Delivery Message (KDM) corresponding with the at least partially encrypted DCP and the first display device paired to the client-side content delivery device, the encrypted first KDM including a content encryption key (CEK) and at least one playback timing parameter of the digital movie, the encrypted first KDM encrypted with a first public key corresponding with the first display device; decrypting, by the client-side content delivery device, the encrypted first KDM using a first private key corresponding to and stored on the first display device; decrypting, by the client-side content delivery device, the at least partially encrypted DCP using the CEK of the decrypted first KDM; and using the decrypted DCP to cause presentation of the digital movie based on the at least one playback timing parameter of the digital movie by the first display device paired to the client-side content delivery device.

In Example 2, the subject matter of Example 1 includes, wherein the at least one playback timing parameter of the digital movie includes a limited timeframe during which the digital movie can be presented.

In Example 3, the subject matter of Examples 1-2 includes, wherein the DCP includes a first compositional variation of the digital movie, the first compositional variation including first playback quality attributes, wherein the first KDM corresponds with the first compositional variation.

In Example 4, the subject matter of Example 3 includes, wherein the first playback quality attributes include at least one of a specified picture resolution or a specified audio compression format.

In Example 5, the subject matter of Examples 3-4 includes, receiving from the digital content delivery system, a second public key antecedently transmitted to the digital content delivery system by a second display device paired to the client-side content delivery device, the second public key corresponding with the second display device; receiving, by the client-side content delivery device, an encrypted second KDM corresponding with the at least partially encrypted DCP and the second display device paired to the client-side content delivery device, the encrypted second KDM encrypted with a second public key corresponding with the second display device; decrypting, by the client-side content delivery device, the encrypted second KDM using a second private key corresponding to and stored on the second display device; decrypting, by the client-side content delivery device, the at least partially encrypted DCP using a CEK included in the decrypted second KDM, wherein the DCP includes a second compositional variation of the digital movie corresponding with the second KDM, the second compositional variation including second playback quality attributes, different from the first playback quality attributes; and using the DCP to cause presentation of the digital movie based on the second playback quality attributes of the second compositional variation by the second display device paired to the client-side content delivery device.

In Example 6, the subject matter of Examples 1-5 includes, wherein the first public key and the first private key are a pair of related keys generated using an asymmetric key algorithm including at least one one-way function.

In Example 7, the subject matter of Example 6 includes, wherein the first KDM cannot be decrypted using the first public key and the first private key and the first public key cannot be derived from each other.

Example 8 is a client-side content delivery device comprising: one or more computer processors; and one or more computer-readable mediums storing instructions that, when executed by the one or more computer processors, cause the client-side content delivery device to perform operations comprising: receiving, by a client-side content delivery device, an at least partially encrypted digital cinema package (DCP) for a digital movie, the at least partially encrypted DCP received from a digital content delivery system that is remote to the client-side content delivery device, the at least partially encrypted DCP including a first persistent unique digital watermark antecedently applied to the at least partially encrypted DCP by the digital content delivery system; receiving from the digital content delivery system, a first public key antecedently transmitted to the digital content delivery system by a first display device paired to the client-side content delivery device, the first public key corresponding with the first display device; receiving, by the client-side content delivery device, an encrypted first Key Delivery Message (KDM) corresponding with the at least partially encrypted DCP and the first display device paired to the client-side content delivery device, the encrypted first KDM including a content encryption key (CEK) and at least one playback timing parameter of the digital movie, the encrypted first KDM encrypted with a first public key corresponding with the first display device; decrypting, by the client-side content delivery device, the encrypted first KDM using a first private key corresponding to and stored on the first display device; decrypting, by the client-side content delivery device, the at least partially encrypted DCP using the CEK of the decrypted first KDM; and using the decrypted DCP to cause presentation of the digital movie based on the at least one playback timing parameter of the digital movie by the first display device paired to the client-side content delivery device.

In Example 9, the subject matter of Example 8 includes, wherein the at least one playback timing parameter of the digital movie includes a limited timeframe during which the digital movie can be presented.

In Example 10, the subject matter of Examples 8-9 includes, wherein the DCP includes a first compositional variation of the digital movie, the first compositional variation including first playback quality attributes, wherein the first KDM corresponds with the first compositional variation.

In Example 11, the subject matter of Example 10 includes, wherein the first playback quality attributes include at least one of a specified picture resolution or a specified audio compression format.

In Example 12, the subject matter of Examples 10-11 includes, wherein the instructions cause the client-side content delivery device to perform operations comprising: receiving from the digital content delivery system, a second public key antecedently transmitted to the digital content delivery system by a second display device paired to the client-side content delivery device, the second public key corresponding with the second display device; receiving, by the client-side content delivery device, an encrypted second KDM corresponding with the at least partially encrypted DCP and the second display device paired to the client-side content delivery device, the encrypted second KDM encrypted with a second public key corresponding with the second display device; decrypting, by the client-side content delivery device, the encrypted second KDM using a second private key corresponding to and stored on the second display device; decrypting, by the client-side content delivery device, the at least partially encrypted DCP using a CEK included in the decrypted second KDM, wherein the DCP includes a second compositional variation of the digital movie corresponding with the second KDM, the second compositional variation including second playback quality attributes, different from the first playback quality attributes; and using the DCP to cause presentation of the digital movie based on the second playback quality attributes of the second compositional variation by the second display device paired to the client-side content delivery device.

In Example 13, the subject matter of Examples 8-12 includes, wherein the first public key and the first private key are a pair of related keys generated using an asymmetric key algorithm including at least one one-way function.

In Example 14, the subject matter of Example 13 includes, wherein the first KDM cannot be decrypted using the first public key and the first private key and the first public key cannot be derived from each other.

Example 15 is a non-transitory computer-readable medium storing instructions that, when executed by one or more computer processors of a client-side content delivery device, cause the client-side content delivery device to perform operations comprising: receiving, by a client-side content delivery device, an at least partially encrypted digital cinema package (DCP) for a digital movie, the at least partially encrypted DCP received from a digital content delivery system that is remote to the client-side content delivery device, the at least partially encrypted DCP including a first persistent unique digital watermark antecedently applied to the at least partially encrypted DCP by the digital content delivery system; receiving from the digital content delivery system, a first public key antecedently transmitted to the digital content delivery system by a first display device paired to the client-side content delivery device, the first public key corresponding with the first display device; receiving, by the client-side content delivery device, an encrypted first Key Delivery Message (KDM) corresponding with the at least partially encrypted DCP and the first display device paired to the client-side content delivery device, the encrypted first KDM including a content encryption key (CEK) and at least one playback timing parameter of the digital movie, the encrypted first KDM encrypted with a first public key corresponding with the first display device; decrypting, by the client-side content delivery device, the encrypted first KDM using a first private key corresponding to and stored on the first display device; decrypting, by the client-side content delivery device, the at least partially encrypted DCP using the CEK of the decrypted first KDM; and using the decrypted DCP to cause presentation of the digital movie based on the at least one playback timing parameter of the digital movie by the first display device paired to the client-side content delivery device.

In Example 16, the subject matter of Example 15 includes, wherein the at least one playback timing parameter of the digital movie includes a limited timeframe during which the digital movie can be presented.

In Example 17, the subject matter of Examples 15-16 includes, wherein the DCP includes a first compositional variation of the digital movie, the first compositional variation including first playback quality attributes, wherein the first KDM corresponds with the first compositional variation.

In Example 18, the subject matter of Example 17 includes, wherein the first playback quality attributes include at least one of a specified picture resolution or a specified audio compression format.

In Example 19, the subject matter of Examples 17-18 includes, wherein the instructions cause the client-side content delivery device to perform operations comprising: receiving from the digital content delivery system, a second public key antecedently transmitted to the digital content delivery system by a second display device paired to the client-side content delivery device, the second public key corresponding with the second display device; receiving, by the client-side content delivery device, an encrypted second KDM corresponding with the at least partially encrypted DCP and the second display device paired to the client-side content delivery device, the encrypted second KDM encrypted with a second public key corresponding with the second display device; decrypting, by the client-side content delivery device, the encrypted second KDM using a second private key corresponding to and stored on the second display device; decrypting, by the client-side content delivery device, the at least partially encrypted DCP using a CEK included in the decrypted second KDM, wherein the DCP includes a second compositional variation of the digital movie corresponding with the second KDM, the second compositional variation including second playback quality attributes, different from the first playback quality attributes; and using the DCP to cause presentation of the digital movie based on the second playback quality attributes of the second compositional variation by the second display device paired to the client-side content delivery device.

In Example 20, the subject matter of Examples 15-19 includes, wherein the first public key and the first private key are a pair of related keys generated using an asymmetric key algorithm including at least one one-way function.

Example 21 is at least one machine-readable medium including instructions that, when executed by processing circuitry, cause the processing circuitry to perform operations to implement any of Examples 1-20.

Example 22 is an apparatus comprising means to implement any of Examples 1-20.

Example 23 is a system to implement any of Examples 1-20.

Example 24 is a method to implement any of Examples 1-20.

The above Detailed Description can include references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that can include elements in addition to those listed after such a term in a claim are still deemed to fall within the scope of that claim.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” can include “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that can include elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) can be used in combination with each other. Other embodiments can be used, such as by one of ordinary skill in the art upon reviewing the above description. The Abstract is provided to comply with 37 C.F.R. § 1.72 (b), to allow the reader to quickly ascertain the nature of the technical disclosure. It is submitted with the understanding that it will not be used to interpret or limit the scope or meaning of the claims. Also, in the above Detailed Description, various features can be grouped together to streamline the disclosure. This should not be interpreted as intending that an unclaimed disclosed feature is essential to any claim. Rather, inventive subject matter can lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

What is claimed is:

1. A method comprising:
receiving, by a client-side content delivery device, an at least partially encrypted digital cinema package (DCP) for a digital movie, the at least partially encrypted DCP received from a digital content delivery system that is remote to the client-side content delivery device, the at least partially encrypted DCP including a first persistent unique digital watermark antecedently applied to the at least partially encrypted DCP by the digital content delivery system;
receiving from the digital content delivery system, a first public key antecedently transmitted to the digital content delivery system by a first display device paired to the client-side content delivery device, the first public key corresponding with the first display device;
receiving, by the client-side content delivery device, an at least partially encrypted first Key Delivery Message (KDM) corresponding with the at least partially encrypted DCP and the first display device paired to the client-side content delivery device, the at least partially encrypted first KDM including a content encryption key (CEK) and at least one playback timing parameter of the digital movie, the at least partially encrypted first KDM encrypted with a first public key corresponding with the first display device;
decrypting, by the client-side content delivery device, the at least partially encrypted first KDM using a first private key corresponding to and stored on the first display device;
decrypting, by the client-side content delivery device, the at least partially encrypted DCP using the CEK of the decrypted first KDM; and
using the decrypted DCP to cause presentation of the digital movie based on the at least one playback timing parameter of the digital movie by the first display device paired to the client-side content delivery device.

2. The method of claim 1, wherein the at least one playback timing parameter of the digital movie includes a limited timeframe during which the digital movie can be presented.

3. The method of claim 1, wherein the DCP includes a first compositional variation of the digital movie, the first compositional variation including first playback quality attributes, wherein the first KDM corresponds with the first compositional variation.

4. The method of claim 3, wherein the first playback quality attributes include at least one of a specified picture resolution or a specified audio compression format.

5. The method of claim 3, comprising:
receiving from the digital content delivery system, a second public key antecedently transmitted to the digital content delivery system by a second display device paired to the client-side content delivery device, the second public key corresponding with the second display device;
receiving, by the client-side content delivery device, an at least partially encrypted second KDM corresponding with the at least partially encrypted DCP and the second display device paired to the client-side content delivery device, the at least partially encrypted second KDM encrypted with a second public key corresponding with the second display device;
decrypting, by the client-side content delivery device, the at least partially encrypted second KDM using a second private key corresponding to and stored on the second display device;
decrypting, by the client-side content delivery device, the at least partially encrypted DCP using a CEK included in the decrypted second KDM, wherein the DCP includes a second compositional variation of the digital movie corresponding with the second KDM, the second compositional variation including second playback quality attributes, different from the first playback quality attributes; and
using the DCP to cause presentation of the digital movie based on the second playback quality attributes of the second compositional variation by the second display device paired to the client-side content delivery device.

6. The method of claim 1, wherein the first public key and the first private key are a pair of related keys generated using an asymmetric key algorithm including at least one one-way function.

7. The method of claim 6, wherein the first KDM cannot be decrypted using the first public key and the first private key and the first public key cannot be derived from each other.

8. A client-side content delivery device comprising:
one or more computer processors; and
one or more computer-readable mediums storing instructions that, when executed by the one or more computer processors, cause the client-side content delivery device to perform operations comprising:
receiving, by a client-side content delivery device, an at least partially encrypted digital cinema package (DCP) for a digital movie, the at least partially encrypted DCP received from a digital content delivery system that is remote to the client-side content delivery device, the encrypted DCP including a first persistent unique digital watermark antecedently applied to the at least partially encrypted DCP by the digital content delivery system;
receiving from the digital content delivery system, a first public key antecedently transmitted to the digital content delivery system by a first display device paired to the client-side content delivery device, the first public key corresponding with the first display device;
receiving, by the client-side content delivery device, an at least partially encrypted first Key Delivery Message (KDM) corresponding with the at least partially encrypted DCP and the first display device paired to the client-side content delivery device, the at least partially encrypted first KDM including a content encryption key (CEK) and at least one playback timing parameter of the digital movie, the at least partially encrypted first KDM encrypted with a first public key corresponding with the first display device;
decrypting, by the client-side content delivery device, the at least partially encrypted first KDM using a first private key corresponding to and stored on the first display device;
decrypting, by the client-side content delivery device, the at least partially encrypted DCP using the CEK of the decrypted first KDM; and
using the decrypted DCP to cause presentation of the digital movie based on the at least one playback timing parameter of the digital movie by the first display device paired to the client-side content delivery device.

9. The client-side content delivery device of claim 8, wherein the at least one playback timing parameter of the digital movie includes a limited timeframe during which the digital movie can be presented.

10. The client-side content delivery device of claim 8, wherein the DCP includes a first compositional variation of the digital movie, the first compositional variation including first playback quality attributes, wherein the first KDM corresponds with the first compositional variation.

11. The client-side content delivery device of claim 10, wherein the first playback quality attributes include at least one of a specified picture resolution or a specified audio compression format.

12. The client-side content delivery device of claim 10 wherein the instructions cause the client-side content delivery device to perform operations comprising:
receiving from the digital content delivery system, a second public key antecedently transmitted to the digital content delivery system by a second display device paired to the client-side content delivery device, the second public key corresponding with the second display device;
receiving, by the client-side content delivery device, an at least partially encrypted second KDM corresponding with the at least partially encrypted DCP and the second display device paired to the client-side content delivery device, the at least partially encrypted second KDM encrypted with a second public key corresponding with the second display device;
decrypting, by the client-side content delivery device, the at least partially encrypted second KDM using a second private key corresponding to and stored on the second display device;
decrypting, by the client-side content delivery device, the at least partially encrypted DCP using a CEK included in the decrypted second KDM, wherein the DCP includes a second compositional variation of the digital movie corresponding with the second KDM, the second compositional variation including second playback quality attributes, different from the first playback quality attributes; and
using the DCP to cause presentation of the digital movie based on the second playback quality attributes of the second compositional variation by the second display device paired to the client-side content delivery device.

13. The client-side content delivery device of claim 8, wherein the first public key and the first private key are a pair of related keys generated using an asymmetric key algorithm including at least one one-way function.

14. The client-side content delivery device of claim 13, wherein the first KDM cannot be decrypted using the first public key and the first private key and the first public key cannot be derived from each other.

15. A non-transitory computer-readable medium storing instructions that, when executed by one or more computer processors of a client-side content delivery device, cause the client-side content delivery device to perform operations comprising:
receiving, by a client-side content delivery device, an at least partially encrypted digital cinema package (DCP) for a digital movie, the at least partially encrypted DCP received from a digital content delivery system that is remote to the client-side content delivery device, the at least partially encrypted DCP including a first persistent unique digital watermark antecedently applied to the at least partially encrypted DCP by the digital content delivery system;
receiving from the digital content delivery system, a first public key antecedently transmitted to the digital content delivery system by a first display device paired to the client-side content delivery device, the first public key corresponding with the first display device;
receiving, by the client-side content delivery device, an at least partially encrypted first Key Delivery Message (KDM) corresponding with the at least partially encrypted DCP and the first display device paired to the client-side content delivery device, the at least partially encrypted first KDM including a content encryption key (CEK) and at least one playback timing parameter of the digital movie, the at least partially encrypted first KDM encrypted with a first public key corresponding with the first display device;
decrypting, by the client-side content delivery device, the encrypted first KDM using a first private key corresponding to and stored on the first display device;
decrypting, by the client-side content delivery device, the at least partially encrypted DCP using the CEK of the decrypted first KDM; and
using the decrypted DCP to cause presentation of the digital movie based on the at least one playback timing parameter of the digital movie by the first display device paired to the client-side content delivery device.

16. The non-transitory computer-readable medium of claim 15, wherein the at least one playback timing parameter of the digital movie includes a limited timeframe during which the digital movie can be presented.

17. The non-transitory computer-readable medium of claim 15, wherein the DCP includes a first compositional variation of the digital movie, the first compositional variation including first playback quality attributes, wherein the first KDM corresponds with the first compositional variation.

18. The non-transitory computer-readable medium of claim 17, wherein the first playback quality attributes include at least one of a specified picture resolution or a specified audio compression format.

19. The non-transitory computer-readable medium of claim 17, wherein the instructions cause the client-side content delivery device to perform operations comprising:
receiving from the digital content delivery system, a second public key antecedently transmitted to the digital content delivery system by a second display device paired to the client-side content delivery device, the second public key corresponding with the second display device;
receiving, by the client-side content delivery device, an at least partially encrypted second KDM corresponding with the at least partially encrypted DCP and the second display device paired to the client-side content delivery device, the at least partially encrypted second KDM encrypted with a second public key corresponding with the second display device;
decrypting, by the client-side content delivery device, the at least partially encrypted second KDM using a second private key corresponding to and stored on the second display device;
decrypting, by the client-side content delivery device, the at least partially encrypted DCP using a CEK included in the decrypted second KDM, wherein the DCP includes a second compositional variation of the digital movie corresponding with the second KDM, the second compositional variation including second playback quality attributes, different from the first playback quality attributes; and
using the DCP to cause presentation of the digital movie based on the second playback quality attributes of the second compositional variation by the second display device paired to the client-side content delivery device.

20. The non-transitory computer-readable medium of claim 15, wherein the first public key and the first private key are a pair of related keys generated using an asymmetric key algorithm including at least one one-way function.

21. A method comprising:
receiving, by a client-side digital content delivery device, a digital cinema package (DCP), including at least one encrypted essence file, for a digital movie, the DCP received from a digital content delivery system that is remote to the client-side digital content delivery device, the DCP including a first persistent unique digital watermark antecedently applied to the DCP by the digital content delivery system;
receiving from the digital content delivery system, a first public key antecedently transmitted to the digital content delivery system by a first display device paired to the client-side digital content delivery device, the first public key corresponding with the first display device;
receiving, by the client-side digital content delivery device, a first Key Delivery Message (KDM), including at least one encrypted component, the first KDM corresponding with the DCP and the first display device paired to the client-side content delivery device, the first KDM including a content encryption key (CEK) and at least one playback timing parameter of the digital movie, the first KDM encrypted with a first public key corresponding with the first display device;
decrypting, by the client-side digital content delivery device, the at least one encrypted component included in the first KDM using a first private key corresponding to and stored on the first display device;
decrypting, by the client-side digital content delivery device, the at least one encrypted essence file included in the DCP using the CEK of the decrypted first KDM; and
using the decrypted DCP to cause presentation of the digital movie based on the at least one playback timing parameter of the digital movie by the first display device paired to the client-side digital content delivery device.
